(19) United States
(12) Patent Application Publication
(10) Pub. No.: US 2019/0317580 A1
(43) Pub. Date: Oct. 17, 2019

(54) Method of Determining a Configuration of Multiple Power Supply Units of a Computer System

(71) Applicant: FUJITSU LIMITED, Kawasaki-shi (JP)

(72) Inventor: Yi-Lan Yang, München (DE)

(73) Assignee: FUJITSU LIMITED, Kawasaki-shi (JP)

(21) Appl. No.: 16/379,149

(22) Filed: Apr. 9, 2019

(30) Foreign Application Priority Data
Apr. 12, 2018 (DE) 102018108737.3

(51) Int. Cl. G06F 1/26

(52) U.S. Cl. CPC G06F 1/26

(57) ABSTRACT

A method of determining a configuration of multiple power supply units of a computer system. According to the method, in a first step a time shift between different synchronization signals is evaluated, wherein the different synchronization signals are associated with different power supply units among the multiple power supply units of the computer system. In a subsequent step, a connection configuration of the different power supply units is determined from the evaluated time shift. In this regard, a predetermined first time shift characteristic is associated with a connection configuration of the different power supply units to different power phases of a multiple phase power system, whereas a predetermined second time shift characteristic is associated with a connection configuration of the different power supply units to one shared power phase of the multiple phase power system. With such a method a power management of the computer system may be enhanced.

### BACKGROUND OF THE INVENTION

The invention pertains to a method of determining a configuration of multiple power supply units of a computer system as well as a computer system with multiple power supply units.

In today's data centers with an increasing number of computer systems with multiple power supply units, for example servers with multiple power supply units installed therein, wherein the servers are organized in server racks, power consumption increases significantly. Due to this, the data centers, and the computer systems organized therein, are more and more connected to multiple phase power systems for supplying the multiple power supply units.

Determination of a configuration of the respective power supply units within computer systems of the type mentioned above and balancing of an overall load of the respective computer systems within a data center distributed over the multiple phases of the multiple phase power system, therefore, is an important task. Such a balancing of the overall load may be necessary to maintain a good power factor and a good power quality of the power utility and to prevent any penalty due to power imbalance issues.

Common solutions for a management of multiple phase power systems within a data center and for a balancing of the overall load provide so-called power distribution units (PDUs) installed within the data center, for example, electrically connected between the multiple phases of the power system and the computational units, e.g. the computer systems, servers or server racks. With regard to numerous computational units, e.g. numerous server racks within the data center and numerous servers accommodated in one single server rack, according to common solutions, a large number of intelligent PDUs is possibly necessary to monitor and survey the power usage on each phase of the multiple phases for all computational units within the data center and, if required, to provide alerts on any malfunction, imbalance or degradation of power utility quality.

The intelligent PDUs collect information and data on the overall power quality and power consumption which can be provided to an administrator of the data center. The administrator then can manually redistribute and reorganize the power consumption of the numerous computational units regarding each phase of the multiple phase power system in order to prevent imbalance issues of the type mentioned above.

The disadvantage of the common solutions as explained above lies in the costly provision of lots of PDUs within the power supply infrastructure of a data center, let alone the administrative effort in handling power issues.

### SUMMARY OF THE INVENTION

The present disclosure provides for a method of determining a configuration of multiple power supply units of a computer system as well as such a computer system which may ease a power supply management within a data center.

According to a first aspect, a method of determining a configuration of multiple power supply units of a computer system is described.

The method comprises the following steps:
evaluating a time shift between different synchronization signals, wherein the different synchronization signals are associated with different power supply units among the multiple power supply units of the computer system, and
determining a connection configuration of the different power supply units from the evaluated time shift, wherein a predetermined first time shift characteristic is associated with a connection configuration of the different power supply units to different power phases of a multiple phase power system, and wherein a predetermined second time shift characteristic is associated with a connection configuration of the different power supply units to one shared power phase of the multiple phase power system.

Such a method enables a determination of a configuration of multiple power supply units within a computer system which is easy to implement and can save costs. The connection configuration of different power supply units within the respective computer system can easily be determined by evaluating a time shift between synchronization signals which are associated with different power supply units among the multiple power supply units of the computer system. A first time shift characteristic, thereby, indicates a first type of connection configuration, namely a connection configuration of the different power supply units to different power phases of a multiple phase power system, whereas a predetermined second time shift characteristic indicates a second type of connection configuration, different to the first type of connection configuration, namely a connection configuration of the different power supply units to one shared (common) power phase of the multiple phase power system.

Hence, with the method as explained above, it can be determined for different power supply units of a computer system, whether these power supply units are connected to different power phases or to one shared power phase of a multiple phase power system by simply evaluating a time shift between synchronization signals associated with the different power supply units as explained above. Hence, the method may ease a power management within the respective computer system and therefore, a power management within a data center with multiple computer systems.

The terms “first and second time shift characteristic” may encompass predetermined time/phase shift values or predetermined ranges of time/phase shifts between the different synchronization signals associated with the different power supply units. The first and second time shift characteristics are different to each other for indicating different types of connection configuration as explained above.

The method can be performed for two power supply units within a computer system, thereby determining the connection configurations of the two power supply units as explained above. Alternatively, the method can be performed for a number of power supply units, greater than two, wherein for each of the numerous power supply units a respective connection configuration can be identified.

The method can be performed by one or more evaluation components, implemented directly within the respective computer system. For example, one single evaluation component can be provided for performing the method as explained above. Hence, the method can be automatically performed within the respective computer system without the need for intelligent PDUs of the type explained, which can save costs.

In several implementations of the method each synchronization signal is generated from a zero-crossing detection of a periodic AC supply voltage of the respective power supply unit. For example, a zero-crossing detection of a sinusoidal AC supply voltage as supplied by the respective power supply unit can be performed. Thereby, the sinusoidal AC supply voltage can be the AC supply voltage coming directly from the respective power phase connected to the respective power supply unit or can be a signal processed within the respective power supply unit from the AC supply voltage of the respectively connected power phase. The zero-crossing detection can be performed by a respective component within the respective power supply unit or can be performed by a respective component, for example an evaluation component as explained above, within the computer system. The zero-crossing detection can, for example, be performed such that an essentially rectangular signal is generated as the synchronization signal of the type explained above, wherein signal edges of the rectangular signal are associated with the respective zero-crossings of the periodic, namely sinusoidal, AC supply voltage. Taking into account the explained measures, the method can be easily and effectively implemented.

According to several implementations of the method, each synchronization signal is generated within the respective power supply unit and is transmitted to a separate evaluation component of the computer system, wherein the evaluation component performs the steps of evaluating the time shift between the different synchronization signals and determining a connection configuration of the different power supply units from the evaluated time shift. The evaluation component, in this respect, can be one or more evaluation components of the type explained above. With each synchronization signal generated within the respective power supply unit, the evaluation component of the computer system can be easily implemented without having the need to process supply voltages coming from the respective power supply unit within the evaluation component (or within other components of the computer system). Rather, each synchronization signal is generated within the respective power supply unit and provided to the separate evaluation component for evaluating the time shift between different synchronization signals associated with different power supply units as explained above. This has the advantage that the method is easily scalable to different numbers of power supply units for which a respective connection configuration has to be identified, without having to adapt the functionality of the evaluation component to a greater extent. The evaluation component only has to deal with the respective number of provided synchronization signals for evaluating the respective connection configurations of the involved power supply units.

In several implementations, the method provides the further steps:
evaluating predetermined power characteristics of each power supply unit of the computer system and/or of the respective power phase connected to the respective power supply unit, and
adapting a power delivery percentage for each power supply unit of the computer system depending on the evaluated predetermined power characteristics and depending on the determined connection configuration of the different power supply units.

These measures provide for a balancing of an overall load of the computer system over the involved one or more power phases of the multiple phase power system depending on evaluated predetermined power characteristics of each power supply unit and depending on the determined connection configuration of the different power supply units with one common or different power phases of the multiple phase power system as explained above. Hence, the method may ease a balancing of an overall load of the computer system, and therefore, balancing of the overall load within a data center without the need for one or more intelligent PDUs of the type explained above. Hence, the method may further reduce implementation costs within a data center in an easy but effective manner.

The term “power characteristics of each power supply unit” may encompass an effective value or an absolute value of an amplitude of a periodic AC supply voltage (signal) within a respective power supply unit or of the respective power phase (signal) connected and input to the respective power supply unit. Additionally or alternatively, the “power characteristics of each power supply unit” may encompass a measured value of a power factor or one or more power quality parameters within the power supply unit or a measured value associated with a power quality of the power supply unit or of the respective power phase connected to the respective power supply unit, for example a measured value of a total harmonic distortion of the periodic AC supply voltage.

The power characteristics of the type above can be measured, generated or identified within the respective power supply unit, with regard to the respective power phase connected to the respective power supply unit. Alternatively or additionally, the power characteristics can be measured, generated or identified by a separate evaluation component of the computer system. The latter can be implemented as an evaluation component of the type explained above.

Taking into account these measures, a power delivery percentage for each power supply unit of the computer system can be adapted. For example, in an initial state, the power delivery percentage of two involved power supply units of the computer system is such that each power supply unit delivers 50% of the overall power demand. If it turns out that the power characteristics of the two power supply units become different or change due to an event or situation indicated by the power characteristics, the power delivery percentage of each power supply unit can be amended, such that for example one power supply unit delivers 30% and the other power supply unit delivers 70% of the overall power demand needed for the computer system. Of course, these percentage values are only exemplary.

An amendment or adaptation of the power delivery percentage among the involved power supply units can, for example, be triggered by a voltage difference of the AC supply voltage within a power supply unit with respect to the other involved power supply units of the computer system. This voltage difference may be identified in the course of an evaluation of the respective power characteristics of the involved power supply units. Such a voltage difference may be a voltage drop, for example, being caused by the fact that multiple power supply units draw power/current from one common power phase of the multiple phase power system, such that this phase is loaded more than other phases. This can be compensated by reducing the load of this power phase with regard to other power phases. As an exemplary measure, the power delivery percentage of this phase may be reduced with regard to the power delivery percentage(s) of other phases. In order to maintain a required overall power delivery, however, the delivery percentage(s) of the other phases can be increased.

Hence, by applying the above-explained measures, a dynamic adaptation of the overall power delivery distributed over different power supply units and/or different power phases of a multiple phase power system can be easily performed in order to enhance management and balancing of the power demand within the computer system, and therefore within a data center in order to prevent any degradation of power quality or other imbalance issues of the type mentioned above.

The adaptation of the power delivery percentage, as explained above, can be performed by one or more evaluation components of the type explained above or by any other specially implemented component within the computer system. Hence, a computer system itself can easily perform the explained measures in order to balance its power demand over distributed power supply units and/or distributed power phases without the need for any intelligent PDUs installed within a data center. The adaptation, setting and/or control of the power delivery percentage (or current sharing) among the different power supply units can be communicated between the one or more evaluation components and the different power supply units. The power delivery percentage can be set and/or controlled by one or more components within a respective power supply unit or by one or more other components, for example one or more evaluation components of the type explained above.

According to a second aspect, a computer system is described.

The computer system comprises multiple power supply units and an evaluation component. The multiple power supply units can be two or more power supply units. The evaluation component is configured:
to evaluate a time shift between different synchronization signals associated with different power supply units among the multiple power supply units of the computer system, and
to determine a connection configuration of the different power supply units from the evaluated time shift, wherein a predetermined first time shift characteristic is associated with a connection configuration of the different power supply units to different power phases of a multiple phase power system, and wherein a predetermined second time shift characteristic is associated with a connection configuration of the different power supply units to one shared power phase of the multiple phase power system.

A computer system of the kind explained above allows for an easy management and determination of a connection configuration of different ones of multiple power supply units in the computer system by evaluating a time shift between different synchronization signals associated with the different power supply units.

The evaluation component can be easily implemented as a separate component dedicated to the special functionality as explained above. Hence, the computer system provides for an easy identification and management of a connection configuration of the different power supply units to one shared or different power phases of a multiple phase power system connected to the different power supply units of the computer system. Intelligent PDUs for the monitoring of the power system can be reduced in their number within a data center or can be completely dispensed with. Hence, the computer system contributes to a cost-saving implementation of a full data center containing numerous computer systems of the kind explained above. In addition, the advantages and beneficial aspects of the diverse implementations of the method explained above are also applicable to the above-explained computer system.

According to several embodiments of the computer system, the evaluation component can be implemented as a microcontroller or microprocessor being configured to fulfill the above-explained functionality. Hence, the evaluation component can be easily implemented and integrated into the computer system. Additional intelligent PDUs separate and exterior to the computer system can be effectively reduced or completely dispensed with in order to save costs for an accommodation of numerous computer systems of the kind explained above within a data center, for example within different server racks within a data center.

According to several embodiments of the computer system, each of the different power supply units is configured to generate the respective synchronization signal and to transmit the respective synchronization signal to the evaluation component. In this respect, the evaluation component can be kept simple and only has to be adapted in its functionality of evaluating the respective synchronization signals to the number of synchronization signals to be processed in parallel. In this way, the computer system is easily scalable with regard to the number of the power supply units used therein and the functionality of determining a connection configuration of the respective power supply units as explained above.

According to several embodiments of the computer system, each of the different power supply units comprises a zero-crossing detection component which is configured to detect zero-crossings of a periodic AC supply voltage and to generate the respective synchronization signal. For example, the zero-crossing detection component can be configured to generate the respective synchronization signal as an essentially rectangular signal with signal edges associated with detected zero-crossings of a periodic AC supply voltage, for example a sinusoidal AC supply voltage (signal), input to or generated by the respective power supply unit. The respective synchronization signal generated in this way can be transmitted to the evaluation component of the computer system for evaluating the generated synchronization signal according to the above-explained functionality.

According to several embodiments of the computer system, the evaluation component is provided on a system board, for example a motherboard, of the computer system. In this way, the evaluation component can be easily integrated into the basic functionality of the computer system. Alternatively, the evaluation component can be provided on a daughterboard or extension board electrically/mechanically connected to the system board of the computer system. For example, the evaluation component in this regard can be provided on a specially designed power distribution board connected to the system board for power management of the multiple power supply units of the computer system.

According to several embodiments of the computer system, the evaluation component is further configured:
to evaluate predetermined power characteristics of each of the different power supply units and/or of the respective power phase connected to the respective power supply unit, and
to adapt a power delivery percentage for each of the different power supply units depending on the evaluated predetermined power characteristics and depending on the determined connection configuration of the different power supply units. With respect to the term “power characteristics”, reference is made to the above explanations in view of the above-explained methods. The same shall apply to the term “adaptation of a power delivery percentage” for each of the different power supply units.

According to an exemplary embodiment of the computer system, the evaluation component may be configured to receive measured values of predetermined power characteristics of the respective power supply unit in order to evaluate the power characteristics and to possibly adapt the percentage of the power delivery of the respective power supply unit whose power characteristics are evaluated. For example, the evaluation component is configured to query or poll the predetermined power characteristics of each power supply unit of the computer system for respective evaluation.

According to several embodiments of the computer system, the evaluation component and the multiple power supply units are connected via a communications bus. This communications bus can be a power management bus (PMBus) or a system management bus (SMBus).

According to several embodiments, the computer system is configured as a rack server.

### BRIEF DESCRIPTION OF THE DRAWINGS

Further advantageous aspects are disclosed in the subsequent description of several drawings.

The invention is further described in detail with regard to certain embodiments as illustrated in several drawings.

FIG. 1 shows a schematic configuration of an embodiment of a system board as used in a computer system according to the invention;

FIG. 2 shows characteristic signal curves of phase signals and exemplary synchronization signals derived therefrom according to the invention;

FIG. 3 shows a diagram of measured signal curves of one phase signal and its derived exemplary synchronization signal according to the invention; and

FIG. 4 shows a schematic configuration of an exemplary arrangement of two system boards according to FIG. 1.

### DETAILED DESCRIPTION

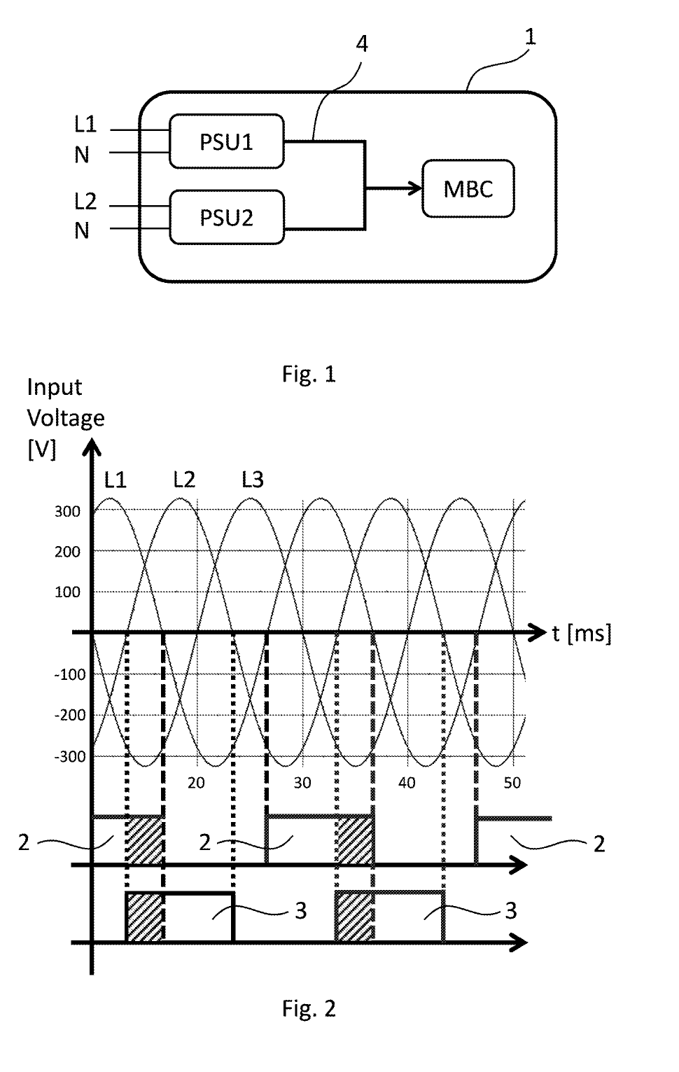

FIG. 1 shows a schematic configuration of an embodiment of a system board 1 used in a computer system, like a server. For example, numerous servers can be accommodated in a server rack, wherein each server comprises one or more system boards 1 according to FIG. 1.

Determination of a configuration of multiple power supply units within a respective server and balancing of an overall load of the respective servers within the server rack (for example within a data center) distributed over multiple phases of a multiple phase power system is an important task. The system board 1 according to the embodiment illustrated in FIG. 1 may ease such a power management within a server rack containing numerous servers.

The system board 1 according to the embodiment of FIG. 1 comprises two power supply units PSU1 and PSU2, each connected to respective power (utility) phases (lines) of a multiple phase power system exterior to the system board 1 and supplying power to the system board 1 provided by a power utility company via a network. For example, according to FIG. 1 the power supply unit PSU1 is connected to the power phase L1 and a neutral line N, whereas the power supply unit PSU2 is connected to the power phase L2 and the neutral line N. Each power supply unit PSU1 and PSU2 may provide a certain amount of power to supply electric components on the system board 1 or other components of the computer system (not illustrated in FIG. 1) for operation of the computer system. For example, the power supply units PSU1 and PSU2 share an overall power demand of the system board 1 or the respective computer system in which the system board 1 is used, wherein both power supply units PSU1 and PSU2 each contribute a predetermined power delivery percentage of an overall power demand. For example, each power supply unit PSU1 and PSU2 provide 50% of the power demand of the system board 1. Other power delivery percentages can be determined depending on the situation as explained below with regard to FIG. 4.

Besides the power supply units PSU1 and PSU2, the system board 1 also provides an evaluation component (Management Board Controller) MBC. According to the embodiment of FIG. 1, the evaluation component MBC is configured as a separate microcontroller managing the power distribution and power supply via the power supply units PSU1 and PSU2. In alternative embodiments, the evaluation component MBC can also be part of or integrated in microprocessor components or microcontroller components conventionally configured on the system board 1. In further alternative embodiments, the evaluation component MBC can be provided on a power distribution board configured separate to the system board 1, for example as a daughter card mechanically and electrically connected to system board 1. Various modifications are possible in this regard.

The evaluation component MBC provides a functionality for evaluating synchronization signals provided by the respective power supply units PSU1 and PSU2 in order to determine a connection configuration of the power supply units PSU1 and PSU2 with regard to the respective power phases L1 and L2 as exemplarily illustrated in FIG. 1. Such a functionality is further explained with regard to FIG. 2 below. Moreover, the evaluation component MBC provides a functionality for evaluating predetermined power characteristics of the power supply units PSU1 and PSU2 and/or of the respective power phases L1 and L2 connected to the power supply units PSU1 and PSU2 as exemplarily illustrated in FIG. 1 in order to adapt a power delivery percentage for each power supply unit PSU1 and PSU2 separately. The latter functionality is further explained below in view of FIG. 4.

FIG. 2 schematically illustrates characteristic curves of AC (supply) voltages (voltage signals) of different phases of a multiple phase power system as applied to the system board 1 according to FIG. 1. Moreover, FIG. 2 illustrates synchronization signals as derived from single AC voltages in order to evaluate and determine a connection configuration of single power supply units PSU1 and PSU2 as configured according to FIG. 1.

For example, the diagram of FIG. 2 illustrates in the upper section the time courses of AC (supply) voltages of three different phases L1, L2 and L3 of the multiple phase power system as applied to the system board 1 according to FIG. 1. In FIG. 1, the two phases L1 and L2 are connected respectively to the two power supply units PSU1 and PSU2 (L1 connected to PSU1 and L2 connected to PSU2).

Turning back to FIG. 2, the three periodic AC (supply) voltages of the phases L1, L2 and L3 provide the AC voltages of a conventional three-phase power system with the three phases L1, L2 and L3. For example, the respective AC (supply) voltages of the phases L1 to L3 each oscillate with a frequency of 50 Hz, which means that the signals each oscillate with a time period of 20 milliseconds, wherein the voltages of the three phases L1 to L3 each are phase-shifted by 120°. Each phase L1 to L3 normally provides, for example, an input voltage with an amplitude of 325 V with an effective value of 230 V. These parameters are illustrated in FIG. 2.

FIG. 2 further illustrates in a lower section synchronization signals 2 and 3 each derived from single ones of the respective AC periodic voltages of the phases L1 to L3. For example, FIG. 2 illustrates synchronization signals 2 derived from the voltage of phase L1 and synchronization signals 3 derived from the voltage of phase L2. Any processing of the voltage of phase L3 is not illustrated in FIG. 2 for the sake of a simple illustration.

The respective synchronization signals 2 and 3 are generated by detecting zero-crossings of the respective periodic AC (supply) voltages. This means that the synchronization signals 2 each provide signal edges associated with the respective zero-crossings of the voltage of phase L1, whereas the synchronization signals 3 each provide signal edges associated with respective zero-crossings of the voltage of phase L2. This is symbolized by respective dashed lines correlating the respective zero-crossings of the voltages of the phases L1 and L2 with the respective signal edges of the synchronization signals 2 and 3.

The synchronization signals 2 and 3 are generated, as exemplarily illustrated in FIG. 2, in such a way that rising edges of the rectangular synchronization signals 2 and 3 correlate/coincide with respective zero-crossings of the respective voltages of the phases L1 or L2 from a negative value to a positive value, whereas falling edges of the rectangular synchronization signals 2 and 3 correlate/coincide with respective zero-crossings of the respective voltages of the phases L1 or L2 from a positive value to a negative value.

The synchronization signals 2 and 3 respectively can be generated with the aid of a zero-crossing detection component within a respective power supply unit PSU1 and PSU2 according to FIG. 1, wherein the zero-crossing detection component is configured to detect the respective zero-crossings of the periodic voltages of the phases L1 and L2 respectively. The synchronization signals 2 and 3 generated in this way can be transmitted from the respective power supply units PSU1 and PSU2 to the evaluation component MBC according to FIG. 1. For this purpose, the power supply units PSU1 and PSU2 and the evaluation component MBC of FIG. 1 are connected via a hardware wiring or communications bus 4, for example a power management bus (PMBus) or a system management bus (SMBus). For example, the respective synchronization signals 2 and 3 according to FIG. 2 can be provided to the hardware wiring at respective synchronization signal pins of connectors/sockets of the respective power supply units PSU1 and PSU2 and transmitted to the evaluation component MBC.

The evaluation component MBC according to FIG. 1 can then evaluate a time shift between the respective synchronization signals 2 and 3 in order to determine a respective connection configuration of the power supply units PSU1 and PSU2 from the evaluated time shift. According to the situation as explained with regard to FIGS. 1 and 2, the evaluation component MBC may identify a time shift between the synchronization signals 2 and 3 due to the overlapping time windows of the respective rectangular synchronization signal components (see the hatched areas of the synchronization signals 2 and 3 in FIG. 2). For example, a rising edge of the synchronization signal 3 starts after a rising edge of the synchronization signal 2 has occurred and before a falling edge of the synchronization signal 2 occurs. This overlap between the synchronization signals 2 and 3 indicates a predetermined time shift characteristic of the opposing synchronization signals 2 and 3. The evaluation component MBC associates this predetermined first time shift characteristic with a connection configuration of the power supply units PSU1 and PSU2 to different power phases L1 and L2 as illustrated in FIG. 1. Hence, the identified time shift characteristic of the two evaluated synchronization signals 2 and 3 enables the determination of the connection configuration of the power supply units PSU1 and PSU2 according to FIG. 1, thereby indicating to the evaluation component MBC that the two power supply units PSU1 and PSU2 are connected to different power phases, namely L1 and L2.

Assuming, according to a scenario alternative to FIGS. 1 and 2, that the two power supply units PSU1 and PSU2 of the arrangement of FIG. 1 would be connected to one shared (common) power supply phase, for example phase L1, alternative to the constellation as depicted in FIG. 1, then an evaluation of a time shift between the synchronization signals 2 and 3 as generated and provided by the power supply units PSU1 and PSU2 would reveal a predetermined second time shift characteristic providing no significant or only a negligible time shift compared to the constellation as illustrated in FIG. 2 between the rectangular signal components of the synchronization signals 2 and 3. Such a scenario, consequently, would indicate to the evaluation component MBC that the two power supply units PSU1 and PSU2 would be connected to one shared (common) phase, namely L1 as exemplarily assumed above.

Hence, due to the measures as explained above, the evaluation component MBC can easily determine and identify a connection configuration of the power supply units PSU1 and PSU2 basing on an evaluation of the time shift between provided synchronization signals 2 and 3 according to the explanations with regard to FIG. 2. Hence, a computer system with a system board 1 as illustrated in the exemplary embodiment according to FIG. 1 and providing the measures as explained with regard to the exemplary constellation illustrated in FIG. 2, can automatically identify the connection configuration of its power supply units as exemplarily illustrated in FIG. 1. Hence, a computer system can provide for a power management without the need of any external monitoring components, e.g. power distribution units or the like. This may save costs in the installation of whole data centers with numerous computer systems of the kind explained above.

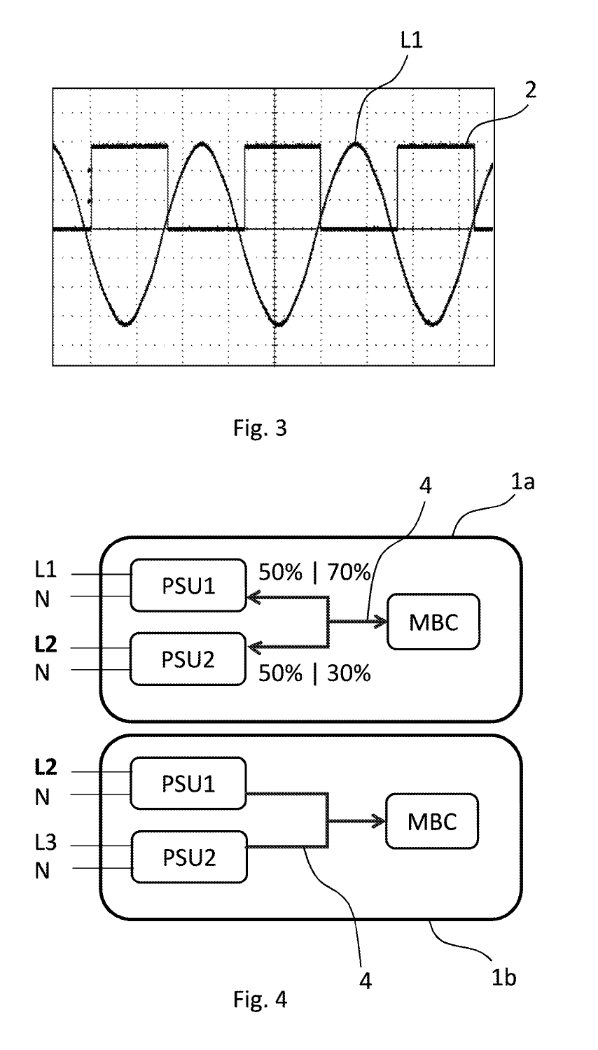

FIG. 3 illustrates measured signal curves of a voltage of a phase (signal) analogous to FIG. 2 and its respective synchronization signal. FIG. 3, thereby, exemplarily illustrates the characteristic curves of a voltage of phase L1 and its respective synchronization signal 2. In contrast to FIG. 2, according to FIG. 3 a rising edge of the synchronization signal 2 occurs during a zero-crossing of the voltage of phase L1 from positive values to negative values, wherein a falling edge of the signal 2 occurs during a zero-crossing of the voltage of phase L1 from negative values to positive values (inverted situation with respect to FIG. 2). Notwithstanding this difference, FIG. 3 illustrates that the synchronization signal 2 has some time shift or drift with respect to its AC voltage of phase L1. This means that the respective signal edge occurs somewhat after the effective zero-crossing of the voltage of phase L1. This drift may originate from factors like measuring tolerances or signal jitter or the like. However, this drift effect is negligible regarding the time shift between two different synchronization signals as explained with regard to the signals 2 and 3 of FIG. 2, such that the occurrence of the drift has no negative impact on the procedure as explained above. Therefore, the respective synchronization signals enable a positive identification and evaluation of respective time shifts for a determination of a connection configuration of the respective power supply units as explained above, irrespective of any negligible drift effect.

FIG. 4 shows an exemplary embodiment of an arrangement of two system boards 1a and 1b which can, for example, be used within two different computer systems accommodated in a rack. This means that the system board 1a, for example, is arranged in a first computer system, wherein the system board 1b is arranged in a second computer system. Alternatively, the two system boards 1a and 1b can be arranged within one single computer system. The two system boards 1a and 1b are each supplied by two power supply units PSU1 and PSU2 as illustrated in FIG. 4. Both system boards 1a and 1b each provide an evaluation unit MBC. Hence, the respective functionality of each system board 1a and 1b corresponds to the functionality of the system board 1 according to FIG. 1. Reference is made to the explanations above.

Power supply unit PSU1 of system board 1a is connected to phase L1 and the neutral line N, whereas power supply unit PSU2 of system board 1a is connected to phase L2 and the neutral line N. Power supply unit PSU1 of system board 1b is connected to phase L2 and the neutral line N, whereas power supply unit PSU2 of system board 1b is connected to phase L3 and the neutral line N.

Both evaluation components MBC of system boards 1a and 1b may determine a respective connection configuration of the power supply units PSU1 and PSU2 respectively. This may be accomplished according to the measures as explained above. Hence, the evaluation component MBC of system board 1a may identify the connection configuration of PSU1 on phase L1 and PSU2 on phase L2 respectively. The evaluation component MBC of system board 1b, analogously, may identify the connection configuration of PSU1 on phase L2 and PSU2 on phase L3.

In addition to synchronization signals transmitted from the respective power supply units PSU1 and PSU2 to the evaluation component MBC, predetermined power characteristics of the power supply units PSU1 and PSU2 respectively and/or of the respective power phases L1, L2 and L3 can be generated through respective measuring components within the power supply units and can be transmitted to the evaluation components MBC. These power characteristics may comprise measurement values of a power factor, total harmonic distortion, voltage difference, for example voltage drop, of the periodic AC voltages or the like. The respective evaluation component MBC then may evaluate the transmitted power characteristics and may adapt a power delivery percentage for each power supply unit PSU1 and PSU2 depending on the evaluated predetermined power characteristics and under consideration of the determined connection configuration of the respective power supply units PSU1 and PSU2.

According to FIG. 4, for example, a power characteristic can be transmitted to the respective evaluation component MBC, indicating a voltage drop on phase L2, since phase L2 is loaded by two power supply units, namely PSU2 of system board 1a and PSU1 of system board 1b, whereas the other phases L1 and L3 are only loaded by one single power supply unit as illustrated in FIG. 4. Such a voltage drop on phase L2 is recognized/evaluated by the evaluation component MBC of each system board 1a and 1b. For example, evaluation component MBC of system board 1a, subsequently, can decide to adapt the power delivery percentage from 50% for each power supply unit PSU1 and PSU2 to an amended power delivery percentage of 70% for PSU1 and 30% for PSU2 in order to lower the stress on phase L2 through PSU2 and to balance the overall power demand in accordance with detected power characteristics as explained above. The same may be performed by evaluation component MBC of system board 1b and its respective power supply units PSU1 and PSU2.

Hence, under consideration of respective connection configurations of the power supply units and under consideration of additionally identified and evaluated power characteristics, the respective evaluation component MBC can balance the overall load of the system board 1a or 1b or other components of a respective computer system over the multiple power supply units. Hence, power management can be automatically fulfilled within respective computer systems without the need for external components, such as intelligent power distribution units or the like, to provide such a functionality. Therefore, this may save costs in the overall implementation of data centers with large numbers of computational units.

The illustrated embodiments are only exemplary. For example, a system board 1, 1a, 1b may provide more than two power supply units. Moreover, the respective power supply units can be installed in the respective computer system separate to the system board and only be electrically connected to the system board. Moreover, more than one evaluation component MBC can be provided on respective system boards or on respective extension boards or daughter cards electrically connected to the respective system boards.

1. Method of determining a configuration of multiple power supply units of a computer system with the following steps:
evaluating a time shift between different synchronization signals, wherein the different synchronization signals are associated with different power supply units among the multiple power supply units of the computer system, and
determining a connection configuration of the different power supply units from the evaluated time shift, wherein a predetermined first time shift characteristic is associated with a connection configuration of the different power supply units to different power phases of a multiple phase power system, and wherein a predetermined second time shift characteristic is associated with a connection configuration of the different power supply units to one shared power phase of the multiple phase power system.

2. Method according to claim 1, wherein each synchronization signal is generated from a zero-crossing detection of a periodic AC supply voltage of the respective power phase of the respective power supply unit.

3. Method according to claim 1, wherein each synchronization signal is generated within the respective power supply unit and is transmitted to a separate evaluation component of the computer system, wherein the evaluation component performs the steps of evaluating the time shift between the different synchronization signals and determining a connection configuration of the different power supply units from the evaluated time shift.

4. Method according to claim 1 with the further steps:
evaluating predetermined power characteristics of each power supply unit of the computer system and/or of the respective power phase connected to the respective power supply unit, and
adapting a power delivery percentage for each power supply unit of the computer system depending on the evaluated predetermined power characteristics and depending on the determined connection configuration of the different power supply units.

5. Computer system with multiple power supply units and an evaluation component,
wherein the evaluation component is configured:
to evaluate a time shift between different synchronization signals associated with different power supply units among the multiple power supply units of the computer system and
to determine a connection configuration of the different power supply units from the evaluated time shift, wherein a predetermined first time shift characteristic is associated with a connection configuration of the different power supply units to different power phases of a multiple phase power system, and wherein a predetermined second time shift characteristic is associated with a connection configuration of the different power supply units to one shared power phase of the multiple phase power system.

6. Computer system according to claim 5, wherein each of the different power supply units is configured to generate the respective synchronization signal and to transmit the respective synchronization signal to the evaluation component.

7. Computer system according to claim 5, wherein the evaluation component is provided on a system board of the computer system.

8. Computer system according to claim 5, wherein the evaluation component is further configured:
to evaluate predetermined power characteristics of each of the different power supply units and/or of the respective power phase connected to the respective power supply unit, and
to adapt a power delivery percentage for each of the different power supply units depending on the evaluated predetermined power characteristics and depending on the determined connection configuration of the different power supply units.

9. Computer system according to claim 5, wherein the evaluation component and the multiple power supply units are connected via a communications bus or hardware wiring.

10. Computer system according to claim 5, wherein the computer system is configured as a rack server.
